(19) United States
(12) Patent Application Publication
(10) Pub. No.: US 2014/0333141 A1
(43) Pub. Date: Nov. 13, 2014

(54) PHOTOVOLTAIC (PV)-BASED AC MODULE AND SOLAR SYSTEMS THEREFROM

(71) Applicant: University of Central Florida Research Foundation, Inc., Orlando, FL (US)

(72) Inventors: HAIBING HU, ORLANDO, FL (US); ISSA BATARSEH, ORLANDO, FL (US); AHMADREZA AMIRAHMADI, ORLANDO, FL (US)

(73) Assignee: University of Central Florida Research Foundation, Inc., Orlando, FL (US)

(21) Appl. No.: 14/272,030

(22) Filed: May 7, 2014

Related U.S. Application Data
(60) Provisional application No. 61/820,287, filed on May 7, 2013.

(51) Int. Cl. H02M 7/5387; H02J 3/00

(52) U.S. Cl. CPC H02M 7/5387; H02J 3/00
USPC 307/84; 363/132

(57) ABSTRACT

A photovoltaic (PV)-based AC module (module) includes a PV panel and a three-phase micro-inverter system attached to or integrated directly into the PV panel including a DC/AC inverter stage including first, second and third phase circuitry each having a plurality of semiconductor power switches. A first, second and third control input driver are coupled to drive control inputs of the plurality of semiconductor power switches in the first, second and third phase circuitry, respectively. The module can include a control unit coupled to drive the first, second and third control input driver, and a transceiver and antenna coupled to the control unit for implementing wireless communications.

### CROSS REFERENCE TO RELATED APPLICATIONS

This application claims the benefit of Provisional Application Ser. No. 61/820,287 entitled “PV-SYSTEM ARCHITECTURE BASED ON THREE-PHASE MICRO-INVERTER FOR PV SOLAR FARM AND COMMERCIAL APPLICATIONS”, filed May 7, 2013, which is herein incorporated by reference in its entirety.

### U.S. GOVERNMENT RIGHTS

This invention was made with U.S. Government support under Department of Energy (DOE) Award Number: DE-EE0003176 awarded by the DOE. The U.S. Government has certain rights in this invention.

### FIELD

Disclosed embodiments relate to PV-systems including DC/AC power inverters.

### BACKGROUND

DC/AC micro-inverters and AC photovoltaic (PV) power modules have witnessed recent market success, their use however being limited to small scale, single phase (typically 110 volts AC (VAC) and 220 VAC) residential and commercial PV installations. For large size PV installations, such as solar farms, with a typical power provided from 1 MW to 500 MW, 3-phase power is provided by wiring all the distributed PV panels to a single centralized DC/AC inverter or string inverter.

### SUMMARY

This Summary is provided to introduce a brief selection of disclosed concepts in a simplified form that are further described below in the Detailed Description including the drawings provided. This Summary is not intended to limit the claimed subject matter's scope.

A photovoltaic (PV)-based alternating current (AC) module includes a PV panel for providing DC source energy from incident sunlight, and a dedicated three-phase micro-inverter system including a DC/AC inverter. The micro-inverter system is typically mechanically attached to the PV panel or further integrated as a part of the PV panel's junction box. The DC/AC inverter includes first, second and third phase circuitry (Phase A, Phase B and Phase C) including semiconductor switches and reactive circuitry.

As used herein, the term “semiconductor power switches” includes field effect transistors (FETs), bipolar junction transistors (BJTs) and Insulated Gate Bipolar Transistor (IGBTs). FETs and IGBTs have gates as their control input, while BJTs have a base as their control input. Thus, although the specific semiconductor switches shown herein are generally Metal Oxide Semiconductor FET (MOSFET) switches, it is understood that the semiconductor power switches can generally be any type of semiconductor power switch.

A solar system includes a plurality of disclosed PV-based AC modules (hereafter “modules”) that are in a distributed arrangement, such as on a rooftop or in an open area as a solar farm, where each module includes a DC/AC inverter stage for converting DC source energy to AC three-phase power. The modules include a control unit that has associated memory which is programmed to implement disclosed communications, such as using a personal area network (PAN), for example ZIGBEE wireless PAN, to exchange data between themselves (adjacent modules) and a central (system) controller.

Disclosed arrangements simplify installation and maintenance-due to plug and play features of the micro-inverter systems and elimination of a high DC voltage hazard, as well as enhancing the solar system's reliability because the failure of any module does not affect the other modules in the solar system. Disclosed embodiments improve the efficiency, reliability, and cost of large size PV installations including Mega-Watt (MW)-class solar farms as well as simplifying system maintenance through the development of relatively low cost, compact, modules that act as “AC bricks”.

### BRIEF DESCRIPTION OF THE DRAWINGS

FIG. 1 shows an example solar system including a plurality of disclosed modules each including a PV panel, a DC/AC inverter stage and a control unit attached to or integrated directly into each PV panel in the system, according to an example embodiment.

FIG. 2 demonstrates a conceptual diagram of an example module where its micro-inverter system functions as a “bridge” connecting between the PV panel and three-phase power grid for converting a DC voltage received from the PV panel into a three-phase voltage, according to an example embodiment.

FIG. 3 shows an example module including a DC/DC converter stage coupled to an DC/AC inverter stage showing an example circuit realization, with a control input driver block for the DC-DC converter and a control input driver block for the DC/AC inverter, according to an example embodiment.

FIG. 4 shows an example solar system implementing a PAN for wireless communications where the modules further comprise a transceiver and antenna which wirelessly communicates to exchange data between themselves and a central controller having a transceiver and antenna, according to an example embodiment.

### DETAILED DESCRIPTION

Disclosed embodiments are described with reference to the attached figures, wherein like reference numerals, are used throughout the figures to designate similar or equivalent elements. The figures are not drawn to scale and they are provided merely to illustrate aspects disclosed herein. Several disclosed aspects are described below with reference to example applications for illustration. It should be understood that numerous specific details, relationships, and methods are set forth to provide a full understanding of the embodiments disclosed herein.

One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. Disclosed embodiments are not limited by the illustrated ordering of acts or events, as some acts may occur in different orders and/or concurrently with other acts or events. Furthermore, not all illustrated acts or events are required to implement a methodology in accordance with this Disclosure.

Notwithstanding that the numerical ranges and parameters setting forth the broad scope of this Disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

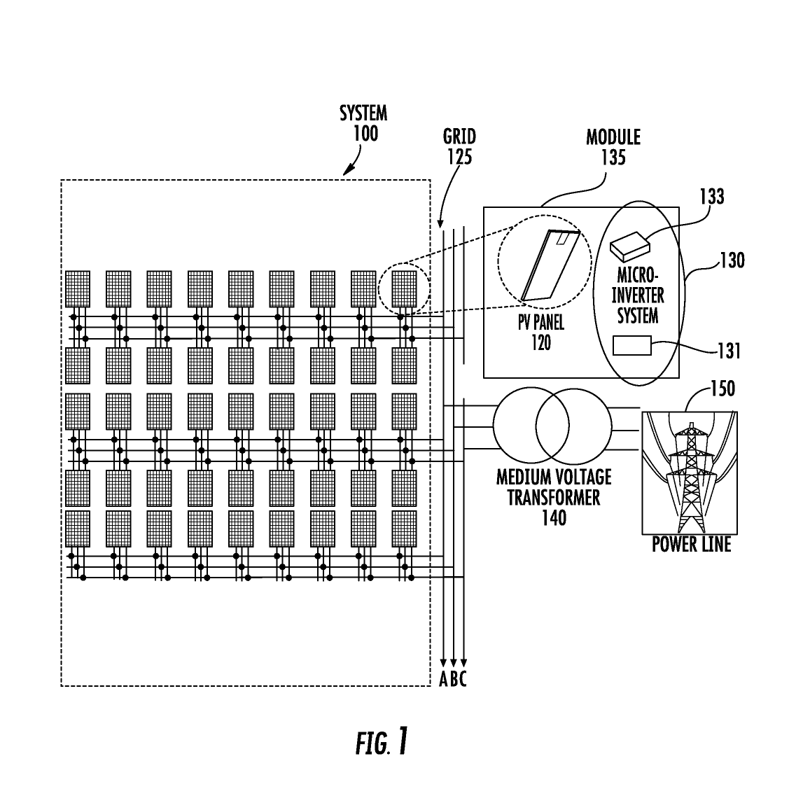

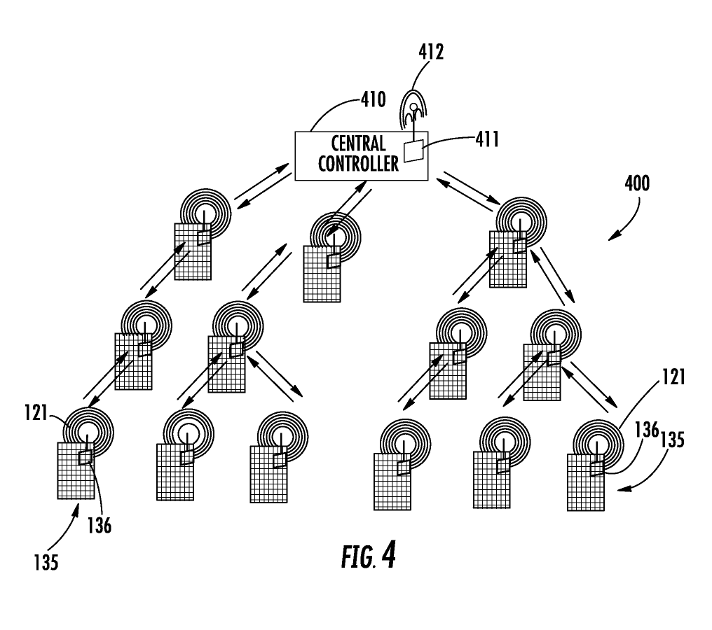

FIG. 1 shows an example solar system 100 including a plurality of disclosed modules 135 each including a PV panel 120, and a three-phase DC/AC micro-inverter system (micro-inverter system) 130 including a control unit 131, where the micro-inverter system 130 is attached to or is integrated directly into each PV panel 120 in the solar system 100. For example, the micro-inverter system can be mechanically attached to the PV panel 120 or further integrated as a part of the PV panel's junction box. The micro-inverter system 130 generally also include at least one control input driver (e.g., gate driver) for driving the respective control inputs of the semiconductor power switches in the micro-inverter system 130. The micro-inverter system 130 generally includes a DC/DC converter stage and the DC/AC inverter stage 130b shown (see FIG. 3 for a module 135′ including a DC/DC converter stage 130a). However, a DC/DC stage may not be needed for certain PV panels that directly output high output voltage (e.g., 200V to 400V). The solar system 100 can comprise a roof-top PV power plant or an open area PV power plant (a “solar farm”).

The control unit 131 implements stored algorithms to provide maximum power point tracking (MPPT), grid synchronization, protection and communications functionality for the micro-inverter system 130. MPPT is a technique to harvest maximum PV power under varying environments, grid synchronization involves matching the voltage frequency and phase of the micro-inverter system 130 to the voltage frequency and phase of the power grid (grid) 125, and protection is also provided against abnormal grid conditions such as over-voltage and communications functionality problems.

The outputs of each micro-inverter system 130 in the modules 135 is directly connected to the grid 125, such as a 208V, 60 Hz three-phase grid and then through a medium voltage transformer 140 that boosts the low three-phase voltage (e.g., 208V, 60 Hz) to a high voltage (e.g., 33 KV) at the power transmission line 150, where all modules 135 are electrically in parallel. Each module 135 can thus operate independently regardless of the failure of any of the other modules 135 in the solar system 100.

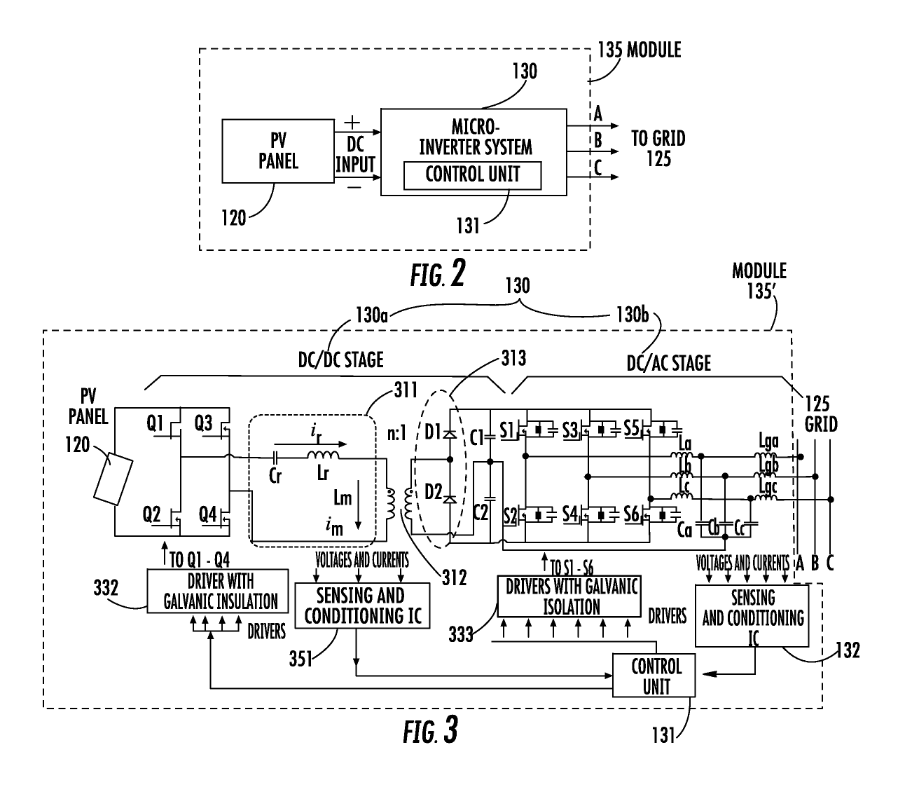

FIG. 2 demonstrates a conceptual diagram of an example demonstrates a module 135 where its micro-inverter system 130 functions as a “bridge” connecting between the PV panel 120 and grid 125 for converting a DC voltage received from the PV panel 120 into a three-phase AC voltage (Phase A, Phase B and Phase C). The control unit 131 embedded inside the module 135 provides functions including protection for the micro-inverter system 130, such as providing a disconnection from the grid 125 during abnormal grid conditions (e.g., grid over voltage more than 120%). Control unit 131 can comprise a digital signal processor (DSP) or microcontroller unit (MCU) which can implement communications such as communicating with a ZIGBEE communication module, and implement MPPT. As known in the art, MPPT is a technique that grid connected inverters, solar battery chargers and similar devices use to obtain the maximum possible power from one or more PV panels. Since solar cells are known to have a complex relationship between solar irradiation, temperature and total resistance that produces a non-linear output efficiency they can be analyzed based on their I-V curve. A MPPT system samples the output of the PV panels and applies the proper resistance (load) to obtain maximum power for any given environmental condition.

Increasing the switching frequency may be a way to reduce cost of the micro-inverter system 130 by shrinking the size of its reactive components. However, this approach can cause a significant power conversion efficiency drop without employing soft switching techniques.

The micro-inverter systems 130 in the solar system 100 can have a single stage or two stages. FIG. 3 shows an example module 135′ including a two-stage micro-inverter system having a DC/DC converter stage 130a coupled to an DC/AC inverter stage 130b each showing example circuit realizations, with a control input driver block 332 for the DC-DC converter stage 130a, and a control input driver block 333 for the DC/AC inverter stage 130b. DC/DC stage 130a receives power generated by the PV panel 120. DC/DC converter stage 130a is shown including MOSFET transistors Q1, Q2, Q3 and Q4, an example series LLC resonant circuitry 311, and a transformer 312 coupled through a diode rectifier 313 to the DC/AC inverter stage 130b.

DC/AC inverter stage 130b is shown as an example half-bridge zero voltage switch circuit including phase A circuitry comprising semiconductor switches S1 and S2 and reactive components, phase B circuitry comprising switches S3 and S4 and reactive components, and phase C circuitry comprising switches S5 and S6 and reactive components. The semiconductor switches S1 to S6 are shown as MOSFETs conventionally configured to have their body diodes parallel to the source-to-drain path by shorting the source to the body of the MOSFET.

The control input driver block 332 provides first, second and third control input drivers embodied as gate driver(s) for Phase A circuitry, gate driver(s) for Phase B circuitry and gate driver for Phase C circuitry which couple to the gates of the MOSFETs (Q1 to Q4) in the DC/AC DC/DC converter stage 130a. The control input driver block 333 provides first, second and third control input drivers embodied as gate driver(s) for Phase A circuitry, gate driver(s) for Phase B circuitry and gate driver for Phase C circuitry which couple to the gates of the MOSFET switches (S1 to S6) in the DC/AC inverter stage 130b. As known in the art, each gate driver generally includes both a high side gate driver and a low side gate driver.

The control unit 131 receives sensed voltages and currents from sensing and conditioning integrated circuit (IC) 351 sensing within the DC/DC converter stage 130a and sensed voltages and currents from sensing and conditioning IC 351 which senses within the DC/AC inverter stage 130b. The drivers can be configured to include galvanic isolation as shown in FIG. 3. Galvanic isolation is a principle of isolating functional sections of electrical systems to prevent current flow; where no direct conduction path is permitted.

FIG. 4 shows an example solar system 400 implementing a PAN for wireless communications where the modules 135 further comprise a transceiver 136 and antenna 121 which wirelessly communicates to exchange data between themselves and a central controller 400 having a transceiver 411 and an antenna 412, according to an example embodiment. Transceiver 136 is coupled to the control unit (not shown in FIG. 4). Communications can utilize a PAN such as ZIGBEE which is a known wireless specification for a suite of high level communication protocols used to create PANs built from small, low-power digital radios, and is based on an IEEE 802.15 standard. Other wireless specifications that implement PANs may also be used with disclosed embodiments.

Each PV-based AC module 135 sends the needed data to manage the plurality of PV panels 120 including its operating voltage, currents, power, frequencies, working status and any faults through a subnet of the modules 135 to the central controller 410, which can comprise a MCU. The central controller 410 includes processor resources to have at least Universal Asynchronous Receiver/Transmitter (UART) or Serial Peripheral Interface (SPI) peripherals to communicate with PAN communications. The central controller 410 sends wireless commands through a subnet of the modules 135 to turn power conversion on/off (e.g., so that a gate drive signal turns off the transistors Q1 to Q4 in the DC/DC converter stage 130a and also the gate drivers of the DC/AC inverter stage 130b) and controls the output reactive power provided by the DC/AC inverter stage 130b.

It is recognized disclosed modules 135 to be advantageous by extending the micro-inverter concept to large size PV plant installations, such as MW-class solar farms where a three-phase AC connection is used. Advantages or benefits of disclosed three-phase micro-inverter-based PV farm systems include significant advantages over traditional PV farm systems that having a single centralized three-phase micro-inverter since they allow MPPT to be implemented on each PV panel 120 to maximize energy harvesting efficiency, and offer a distributed and redundant system architecture. In addition, disclosed modules 135 can significantly simplify system design (including easy modularization and scalability), essentially eliminate safety hazards including making all DC wiring at a relatively low voltage level of a single PV panel, and reducing installation costs. Disclosed micro-inverter systems can be further integrated into PV modules to realize a true plug-and-play solar AC PV generation system.

More specifically, advantages provided by disclosed modules 135 include each PV panel 120 has individualized MPPT. Due to resulting maximum power harnessing from each PV panel 120, solar farm and rooftop system performance degradation due to shading (partial cloudiness) or soiling can be minimized. There is no mismatch losses due to the parallel connection of PV panels 120 to their dedicated DC/AC micro-inverter system 130. Separate micro-inverter systems 130 effectively connect all PV panels 120 in parallel eliminating mismatch losses between PV panels 120. There is ease of installation through a flexible and modular solar farm and rooftop system design.

Conventional electrolytic capacitors can be removed due to the three-phase power balance provided. Unlike single-phase systems, where a bulky power decoupling capacitor is required due to time varying power flow to the grid, three-phase system draws constant power from the micro-inverter systems which allow using the low value, long lifetime film capacitors Disclosed micro inverter systems should significantly reduce installation costs associated with wiring, cabling, DC bus disconnects, and large inverter rooms since each micro inverter system will generate AC power that can be directly coupled to the grid 125. There is also a likely cost reduction due to mass production (economies of scale). Moreover, there will be reduced DC distribution losses because all parallel connected power from each modules 135 is based on AC distribution.

Regarding uses for disclosed modules 135 with the rapid growth of PV power systems in recent years, more and more large-scale PV power plants are being put into use or being built. In 2014 the cumulative power of large PV power plants is more than 3.6 GWp and the PV industry still continues to grow at an unprecedented rate. From this perspective, there has a huge potential large scale deployment for large-scale PV power plants all over world. In 2014, all known large scale PV power plants are based on the centralized inverter technology or string inverter technology, which is recognized to not be able to maximize energy harvest for each PV panel, have high DC voltage hazardous to safety, and are not easy for installation and maintenance. With the advantages described above for disclosed modules 135 the PV power plant architecture based on disclosed three-phase micro-inverter systems at each PV panel can overcome above shortcomings and generally can be applied to any scale three-phase PV power plant, from relatively small scale top-roof applications for commercial building to large scale PV power plants.

While various disclosed embodiments have been described above, it should be understood that they have been presented by way of example only, and not as a limitation. Numerous changes to the disclosed embodiments can be made in accordance with the Disclosure herein without departing from the spirit or scope of this Disclosure. Thus, the breadth and scope of this Disclosure should not be limited by any of the above-described embodiments. Rather, the scope of this Disclosure should be defined in accordance with the following claims and their equivalents.

Although disclosed embodiments have been illustrated and described with respect to one or more implementations, equivalent alterations and modifications will occur to others skilled in the art upon the reading and understanding of this specification and the annexed drawings. While a particular feature may have been disclosed with respect to only one of several implementations, such a feature may be combined with one or more other features of the other implementations as may be desired and advantageous for any given or particular application.

1. A photovoltaic (PV)-based AC module (module), comprising:
a PV panel, and
a three-phase micro-inverter system attached to or integrated directly into said PV panel comprising a DC/AC inverter stage including first, second and third phase circuitry each having a plurality of semiconductor power switches, and
a first, second and third control input driver coupled to drive control inputs of said plurality of semiconductor power switches in said first, second and third phase circuitry, respectively.

2. The module of claim 1, further comprising a DC/DC converter stage having an input for receiving electrical power from said PV panel and an output coupled to an input of said DC/AC inverter stage.

3. The module of claim 1, further comprising a control unit coupled to drive said first, second and third control input driver, and a transceiver and antenna coupled to said control unit for implementing wireless communications.

4. The module of claim 1, wherein said plurality of semiconductor power switches comprise Metal Oxide Semiconductor Field Effect (MOSFET) transistors.

5. The module of claim 2, further comprising voltage and current sensing and conditioning circuitry coupled between wherein said DC/DC converter stage and said control unit and said DC/AC inverter stage and said control unit.

6. A solar system, comprising:
a plurality of photovoltaic (PV)-based AC modules (modules) distributed over an area, each said plurality of modules including:
a PV panel, and
a three-phase DC/AC micro-inverter system attached to or integrated directly into said PV panel comprising a DC/AC inverter stage including first, second and third phase circuitry each having a plurality of semiconductor power switches, a first, second and third control input driver coupled to drive control inputs of said plurality of semiconductor power switches in said first, second and third phase circuitry, respectively; a control unit coupled to drive said first, second and third control input driver, and a transceiver and antenna coupled to said control unit for implementing wireless communications;
a central controller having a transceiver, an antenna and an associated memory that stores communications and grid-support algorithms, wherein said controller is configured to implement said wireless communications with said plurality of modules, and
a three-phase power grid, wherein outputs of each said plurality of modules are electrically parallel to one another and are directly connected to said three-phase power grid.

7. The solar system of claim 6, wherein said plurality of modules further comprise a DC/DC converter stage having an input for receiving electrical power from said PV panel and an output coupled to an input of said DC/AC inverter stage.

8. The solar system of claim 6, wherein said wireless communications utilize a Personal Area Network (PAN).

9. The solar system of claim 7, wherein said plurality of modules further comprise voltage and current sensing and conditioning circuitry coupled between wherein said DC/DC converter stage and said control unit and said DC/AC inverter stage and said control unit.

10. The solar system of claim 6, wherein said plurality of semiconductor power switches comprise Metal Oxide Semiconductor Field Effect (MOSFET) transistors.

11. The solar system of claim 6, further comprising a voltage transformer between said three-phase power grid and a power line.

12. The solar system of claim 6, wherein said first, second and third control input driver are configured to include galvanic isolation.
